(19) United States
(12) Patent Application Publication
(10) Pub. No.: US 2008/0248307 A1
(43) Pub. Date: Oct. 9, 2008

(54) STABLY PASSIVATED GROUP IV SEMICONDUCTOR NANOPARTICLES AND METHODS AND COMPOSITIONS THEREOF

(75) Inventors: David Jurbergs, Austin, TX (US); Elena V. Rogojina, Los Altos, CA (US)

Correspondence Address: Foley & Lardner LLP, 150 East Gilman Street, Madison, WI, 53701-1497, US

(73) Assignee: InnovaLight, Inc.

(21) Appl. No.: 12/028,295

(22) Filed: Feb. 8, 2008

Related U.S. Application Data
(63) Continuation of application No. PCT/US2006/031511, filed on Aug. 11, 2006.
(60) Provisional application No. 60/707,390, filed on Aug. 11, 2005.

(51) Int. Cl. B32B 15/02; B22F 9/00; C23C 22/00

(52) U.S. Cl. 428/405; 148/281; 148/240; 428/403; 977/777; 977/814; 977/897

(57) ABSTRACT

Group IV semiconductor nanoparticles that have been stably passivated with an organic passivation, layer, methods for producing the same, and compositions utilizing stably passivated. Group IV semiconductor nanoparticles are described. In some embodiments, the stably passivated Group IV semiconductor nanoparticles are luminescent Group IV semiconductor nanoparticles with high photoluminescent quantum yields. The stably passivated Group IV semiconductor nanoparticles can be used in compositions useful in a variety of optoelectronic devices.

### RELATED US APPLICATION DATA

This application claims priority to PCT/US2006/031511, filed on Aug. 11, 2006, which claims priority to U.S. Provisional Application No. 60/707,390, filed on Aug. 11, 2005.

### STATEMENT OF GOVERNMENT RIGHTS

The work disclosed herein was done with partial United States government support under Grant No. DE-FG02-03ER86161 from the Department of Energy. The federal government of the United States may have certain rights in the invention.

### FIELD OF DISCLOSURE

This disclosure relates to Group IV semiconductor nanoparticles that have been stably passivated with an organic passivation layer, methods for producing the same, and compositions utilizing stably passivated Group IV semiconductor nanoparticles.

### BACKGROUND

Group IV semiconductor nanoparticles have proven useful in a variety of applications for a wide selection of optoelectronic devices. However, due to problems associated with the stability of Group IV semiconductor nanoparticle surfaces, it has been observed that for luminescent Group IV semiconductor nanoparticles, there is a degradation of luminescence over time.

Such degradation of the luminescence of Group IV semiconductor nanoparticles that results from to the instability of the nanoparticle surface becomes apparent in considering silicon nanoparticle photoluminescence in the visible region of the electromagnetic spectrum. Due to the small particle size and reactivity that results, the stabilization of the photoluminescence in the visible portion of the electromagnetic spectrum of silicon nanoparticles is an indicator of successful surface stability of the nanoparticles, and hence the preservation of the luminescence of such materials.

One example of an approach to increasing the surface stability and hence the quality of photoluminescence of silicon nanoparticles (i.e. nanoparticles that are about 1.0 nm to about 4.0 nm in diameter that emit in the visible portion of the electromagnetic spectrum) has been to passivate the surfaces of the nanoparticles. For some applications, thermal oxidation of the silicon nanoparticle surfaces has proven effective at passivating the nanoparticles. However, for many optoelectronic applications, passivation by oxidation is not appropriate.

An alternative to passivation by surface oxidation is the formation of an organic passivation layer. For example, an extensive review of formation of organic passivation layers on flat and porous bulk surfaces of silicon and germanium surfaces can be found in J. M. Buriak, Chem. Rev., vol. 102, pp. 1271-1308 (2002). The insertion reaction of an unsaturated organic species, such as an alkene or alkyne at a hydrogen-terminated Group IV semiconductor surface site has been known for some time. As detailed in the Buriak review, when the Group IV semiconductor material is silicon, the reaction is referred to as hydrosilylation. In general, this reaction forms a Si—C bond and has been shown to date to provide bulk silicon semiconductor materials some level of protection against chemical attack from certain chemicals.

More specifically, with respect to Group IV semiconductor nanoparticles, the passivation of colloidal dispersions of silicon nanocrystals harvested from porous silicon wafers using hydrosilylation has been demonstrated (Lars H. Lie, et. al., Journal of Electroanalytical Chemistry, 538-539, pp. 183-190 (2002)). However, the surfaces of such Group IV nanomaterials do not have the integrity required for use in range of optoelectronic devices. This is apparent in that silicon nanoparticles so far reported with organic passivation layers have produced Group IV semiconductor nanoparticles with poor quantum yields (˜10% or less) and photoluminescent intensities that are not stable over substantial periods of time.

As covered in the above mentioned review, in the context of hydrosilylation using electrografting of porous bulk silicon surfaces, it has been suggested that oxygen in the solvents used during the hydrosilylation reaction may compete with the binding of alkynes to porous silicon solid. Still, even approaches taking the precaution of using oxygen-free solvents during hydrosilylation of silicon nanoparticles have not proven to overcome the surface stability problems associated with Group IV semiconductor nanoparticles (see for example Swihart et al. US 2004/0229447, Nov. 8, 2004).

Thus, there is a need in the art for Group IV semiconductor nanoparticles having stable organic passivation layers, and methods of producing such materials.

### BRIEF DESCRIPTION OF THE DRAWINGS

FIG. 1 shows the relationship between particle size and photoluminescence wavelength and energy for silicon nanoparticles.

FIG. 2 shows a flow diagram for producing stably passivated Group IV semiconductor nanoparticles.

FIGS. 3A and 3B are a comparison of the photoluminescence spectrum of untreated silicon nanoparticles (FIG. 5A) versus that of a dispersion of an embodiment of silicon nanocrystals produced using the disclosed method of passivating Group IV semiconductor nanoparticle materials (FIG. 5B).

FIG. 4 shows and FTIR spectra of an embodiment of the disclosed stabilized materials processed in inert conditions having high quantum yields versus materials produced using previously reported methods.

### DETAILED DESCRIPTION

What is disclosed herein provides for embodiments of stable Group IV semiconductor nanoparticles having a stable organic passivation layer, methods for producing such Group IV semiconductor nanoparticles, as well as embodiments of composition utilizing stably passivated Group IV semiconductor nanoparticles.

The materials, methods, and compositions evolved from the inventors' observations that by keeping some embodiments of the Group IV semiconductor nanoparticles in an inert environment from the moment they are formed through the formation of an organic passivation layer on their surfaces, that the material so produced has stabilized luminescence. As will be discussed in more detail below, such luminescence is observed in phenomena such as high quantum yield and intensity of photoluminescence emitted from such embodiments of the Group IV semiconductor nanoparticles. Moreover Fourier Transform Infrared (FTIR) spectroscopic analysis finds embodiments of stably passivated Group IV nanoparticles disclosed herein substantially oxide free in comparison to prior art Group IV nanoparticles.

As used herein, the term “Group IV semiconductor nanoparticle” generally refers to Group IV semiconductor particles having an average diameter between about 1.0 nm to 100.0 nm and may, in some instances, include elongated particle shapes, such as nanowires, or irregular shapes, in addition to more regular shapes, such as spherical, hexagonal, and cubic nanoparticles. In that regard, Group IV semiconductor nanoparticles have an intermediate size between individual atoms and macroscopic bulk solids. In some embodiments, Group IV semiconductor nanoparticles have a size on the order of the Bohr exciton radius (e.g. 4.9 nm), or the de Broglie wavelength, which allows individual Group IV semiconductor nanoparticles to trap individual or discrete numbers of charge carriers, either electrons or holes, or excitons, within the particle. The Group IV semiconductor nanoparticles may exhibit a number of unique electronic, magnetic, catalytic, physical, optoelectronic and optical properties due to quantum confinement and surface energy effects. For example, some embodiments of Group IV semiconductor nanoparticles exhibit photoluminescence effects that are significantly greater than the photoluminescence effects of macroscopic materials having the same composition. Additionally, these quantum confinement effects vary as the size of the nanoparticle is varied. For example, the color of the photoluminescence emitted by some embodiments of the Group IV semiconductor nanoparticles varies as a function of the size of the nanoparticle.

It is contemplated that suitable quality Group IV semiconductor nanoparticles are used as starting materials for the compositions disclosed herein. As will be discussed in more detail subsequently, particle quality includes, but is not limited by, particle morphology, average size and size distribution. For embodiments of disclosed stably passivated Group IV semiconductor particles, suitable nanoparticle materials useful as starting materials have distinct particle morphology, with low incidence of particle clumping, agglomeration, or fusion. As mentioned previously, and will be discussed in more detail subsequently, the properties that are imparted for Group IV semiconductor nanoparticles are related closely to the particle size. In that regard, for many applications, a monodisperse population of particles of specific diameters is also indicated.

With respect to an example of particle quality, transmission electron micrograph (TEM) images were taken of silicon nanoparticles of suitable quality as the starting material for some embodiments of stably passivated Group IV semiconductor nanoparticle materials disclosed herein. The particles have an average diameter of about 10.0 nm, clearly have the morphology of distinct particles, and appear to be fairly monodispersed. In contrast, in the TEM of a commercially available preparation of silicon nanoparticles, considerable fusion between particles is evident, in which networks of amorphous material bridge nanoparticle material. Upon careful inspection, it can also be seen that very small particles are fused with fairly large particles, so that polydispersity is also evident in this sample.

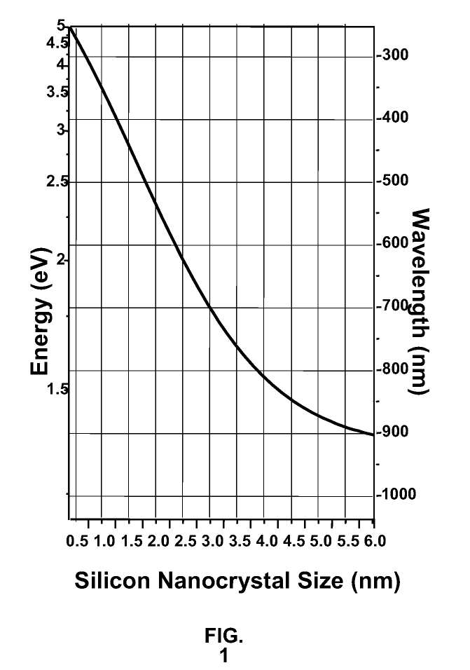

In consideration of the relationship between particle size and unique properties of Group IV semiconductor nanoparticles, an example of such a relationship is given in FIG. 1. FIG. 1 is a graph that shows the relationship for luminescent emission and energy as a function of silicon nanoparticle size. From FIG. 1, it can be seen that particle sizes of between approximately 1.0 nm to about 4.0 nm are luminescent over wavelengths in the visible portion of the electromagnetic spectrum. In that regard, given that the range of what is described as colloidal material is between 1.0 nm to 1.0 micron, then nanoparticles in the visible range of the electromagnetic spectrum are at the low end of what is defined as colloidal. Additionally, for these small nanoparticles, the surface area to volume ratio, which is inversely proportional to radius, is in the range of a thousand times greater than for colloids in the 1.0 micron range. These high surface areas, as well as other factors, such as, for example, the strain of the Group IV atoms at curved surfaces, are conjectured to account for what we have observed, which has not been generally reported in the literature, as the extraordinary reactivity of these small Group IV semiconductor nanoparticles.

As a result of this observation, scrupulous care has been taken to produce and stably passivate Group IV semiconductor nanoparticles. In that regard, for embodiments of the Group IV semiconductor nanoparticles having a photoluminescence in the visible region is an indicator of successful passivation and stabilization of Group IV semiconductor nanoparticles in the range of about 1.0 nm to about 100.0 nm. First, they are the smallest and most reactive of the particles, representing the greatest challenge for stabilization. Second, since they have photoluminescence in the visible region of the electromagnetic spectrum, then stable, high quantum yield of the photoluminescence is an indicator that embodiments of disclosed stably passivated Group IV semiconductor nanoparticles have properties that previously reported passivated Group IV semiconductor nanoparticles lack.

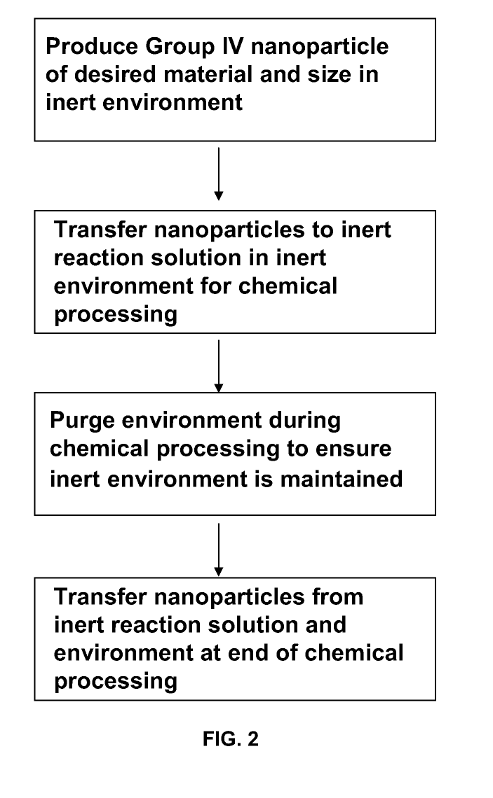

In FIG. 2, a flow diagram summarizes the steps for producing stably passivated Group IV semiconductor nanoparticles in the range of about 1.0 nm to about 100.0 nm.

The first step for producing embodiments of the disclosed stably passivated Group IV semiconductor nanoparticles is to produce quality nanoparticles in an inert environment. For the purposes of this disclosure, an inert environment is an environment in which there are no fluids (ie. gases, solvents, and solutions) that react in such a way that they would negatively affect the luminescence of the Group IV semiconductor nanoparticles, such as the photoluminescence of such nanoparticles. In that regard, an inert gas is any gas that does not react with the Group IV semiconductor nanoparticles in such a way that it negatively affects the luminescence, such as the photoluminescence of the Group IV semiconductor nanoparticles. Likewise, an inert solvent is any solvent that does not react with the Group IV semiconductor nanoparticles in such a way that it negatively affects the luminescence, such as the photoluminescence of the Group IV semiconductor nanoparticles. Finally, an inert solution is mixture of two or more substances that does not react with the Group IV semiconductor nanoparticles in such a way that it negatively affects the luminescence, such as the photoluminescence of the Group IV semiconductor nanoparticles.

Accordingly, the Group IV semiconductor nanoparticles may be made according to any suitable method, several of which are known, provided they are initially formed in an environment that is substantially inert. Examples of inert gases that may be used to provide an inert environment include nitrogen and the rare gases, such as argon. Though not limited by defining inert as only oxygen-free, since other gases may react in such a way that they negatively affect the luminescence of Group IV semiconductor nanoparticles, it has been observed that a substantially oxygen-free environment is indicated for producing suitable Group IV semiconductor nanoparticles. As used herein, the terms “substantially oxygen free” in reference to environments, solvents, or solutions refer to environments, solvents, or solutions wherein the oxygen content has been reduced in an effort to eliminate or minimize the oxidation of Group IV semiconductor nanoparticles in contact with those environments, solvents, or solutions. As such, the Group IV semiconductor nanoparticles starting materials are processed in inert, substantially oxygen-free conditions until they are stably passivated.

In some instances a substantially oxygen-free conditions will contain no more than about 100 ppm oxygen (O₂). This includes embodiments where the substantially oxygen-free conditions contain no more than about 1 ppm oxygen and further includes embodiments where the substantially oxygen-free conditions contain no more than about 100 ppb oxygen. For example, if the Group IV semiconductor nanoparticles are made in a solvent phase, they should be removed from solvent and further processed under vacuum or an inert, substantially oxygen-free atmosphere. In another example, the solvent in which the Group IV semiconductor nanoparticles are made may be an anhydrous, deoxygenated liquid held under vacuum or inert gas to minimize the dissolved oxygen content in the liquid. Alternatively, the Group IV semiconductor nanoparticles may be made in the gas phase or in a plasma reactor in an inert, substantially oxygen-free atmosphere.

Examples of methods for making Group IV semiconductor nanoparticles include plasma aerosol synthesis, gas-phase laser pyrolysis, chemical or electrochemical etching from larger Group IV semiconductor particles, reactive sputtering, sol-gel techniques, SiO₂ implantation, self-assembly, thermal vaporization, synthesis from inverse micelles, and laser ablation/immobilization on self-assembled monolayers.

When the Group IV semiconductor nanoparticles are made by etching larger nanoparticles to a desired size, the nanoparticles are considered to be “initially formed” once the etching process is completed. Descriptions of etching may be found in references such as Swihart et al. US 2004/0229447, Nov. 8, 2004. In the preparation of such descriptions for etching, there is no disclosure for maintaining the Group IV semiconductor materials in an inert, substantially oxygen-free environment. When preparing etched Group IV semiconductor nanoparticles as starting material for embodiments of the disclosed passivated Group IV semiconductor nanoparticles, subsequent to the etching step done under oxidizing conditions, a final etch step using a substantially oxygen-free solution of aqueous hydrofluoric add (HF) is done, and further processing is done so as to maintain the nanoparticles in substantially oxygen-free conditions. For example, the hydrogen-terminated Group IV nanoparticles so formed may be transferred t to an inert, substantially oxygen-free environment.

It is contemplated that plasma phase methods for producing Group IV semiconductor nanoparticles produce Group IV semiconductor nanoparticles of the quality suitable for use in making embodiments of disclosed stably passivated Group IV semiconductor nanoparticles. Such a plasma phase method, in which the particles are formed in an inert, substantially oxygen-free environment, is disclosed in U.S. patent application Ser. No. 11/155,340, filed Jun. 17, 2005; the entirety of which is incorporated herein by reference.

In reference to step 2 of FIG. 2, once Group IV semiconductor nanoparticles having a desired size and size distribution have been formed in an inert, substantially oxygen-free environment, they are transferred to an inert substantially oxygen-free reaction solution for synthesis of the organic passivation layer. The reaction solution is composed of an inert, substantially oxygen-free reaction solvent and an organic reactant. Examples of inert reaction solvents contemplated for use include, but are not limited to mesitylene, xylene, toluene, chlorobenzene, and hexanes. This transfer may take place under vacuum or under an inert, substantially oxygen-free environment. In order to provide inert, substantially oxygen-free reaction solutions, the solutions are composed of anhydrous, deoxygenated organic solvents and organic reactants. The reaction solutions so formed are desirably held under an inert, substantially oxygen-free environment, for example, but not limited by, held under a nitrogen environment in a glove box. In the reaction solution, the nanoparticles undergo reaction with organic reactants to provide an organic passivation layer on their surfaces. This passivation layer is typically a stable, densely packed organic monolayer covalently bonded directly to the nanoparticle surface through Group IV atom-C bonds.

One example of a reaction that is used for creating an organic passivation layer on Group IV semiconductor nanoparticle materials is an insertion reaction between the hydrogen-terminated Group IV atoms at the nanoparticles surface and alkenes or alkynes. For the Group IV semiconductor elements of interest, which are silicon, germanium, and tin, the reaction is referred to as hydrosilylation, hydrogermylation, and hydrostannylation, respectively. Various suitable protocols for this class of insertion reaction are known. These include protocols involving a free-radical initiator, thermally induced insertion, photochemical insertion using ultraviolet or visible light, and metal complex mediated insertion. Some examples of organic species of interest include, but are not limited to simple alkenes, such as octadecene, hexadecane, undecene, and phenyl acetylene. It is contemplated that for some embodiments of stably passivated Group IV nanoparticles, more polar organic moieties such as those containing heteroatoms, or amine of hydroxyl groups are indicated. Where thermally induced insertion is used, higher boiling inert reaction solvents, such as mesitylene or chlorobenzene, are indicated for reaction solution compositions. In some instances, when the organic reactant is a high boiling solvent, such as octadecene, it may be used neat as the reaction solution.

Additionally, other reactions are known for creating stably passivated Group IV semiconductor nanoparticles. Descriptions of protocols for the above described insertion reaction, and other known reactions for forming Group IV semiconductor element-carbon bonds may be found in J. M. Buriak, Chem. Rev,, vol. 102, pp. 1271-1308 (2002), the entire disclosure of which is incorporated herein by reference.

With respect to step 3 of FIG. 2, and in consideration of facilities for carrying out reactions in inert, substantially oxygen-free environments, several approaches are possible. Techniques for working with air-sensitive materials are known, and can be found for instance in The Manipulation of Air-Sensitive Compounds, 2nd Ed., by Duward F. Shriver, and M. A. Drezdzon, Wiley: New. York, 1986. Moreover, even with knowledge of known techniques, the highly-reactive Group IV semiconductor nanoparticles require a scrupulous degree of care for maintaining inert conditions during the preparation of the particles, as well as providing inert conditions for the synthetic step of creating an organic passivation layer, as indicated in step 1 and step 2 of FIG. 2. Additionally, as indicated in step 3 of FIG. 2, it was observed that a constant purge of the environment during the reaction to create stably passivated Group IV semiconductor nanoparticles was necessary to ensure that an inert environment is maintained.

Finally, in step 4 of FIG. 2, once the Group IV semiconductor nanoparticles have been stably passivated with an organic passivation layer under inert conditions, the passivated Group IV semiconductor nanoparticles may be removed from the inert conditions, where they are stable in air. For example, the soluble passivated nanoparticles may be purified by filtering and washing to precipitate the nanoparticles in using typical laboratory procedures without taking precautions to further handle the stably passivated Group IV semiconductor nanoparticles under inert conditions.

Transmission electron micrographs of silicon nanoparticles with an octadecyl passivation layer were taken. The diameter of the particles is on average 3.36 nm, with a standard deviation of 0.74 nm, and as such, these stably passivated nanoparticles have a photoluminescence in the visible region. From these micrographs, not only the size of the particles can be determined, but it is also apparent that the stably passivated nanoparticles have high crystallinity.

Embodiments of the resulting stably passivated Group IV semiconductor nanoparticles in the size range between about 1.0 nm to about 4.0 nm are characterized by high photoluminescent quantum yields and high photoluminescence intensities that are stable over long periods. The methods may be used to produce Group IV semiconductor nanoparticles that photoluminescence at colors across the visible spectrum. For example, depending upon the size and size distribution of embodiments of the stably passivated Group IV semiconductor nanoparticles, they may produce red, orange, green, yellow, or blue photoluminescence, or a mixture of these colors. The synthesis of stable Group IV semiconductor nanoparticles that produce photoluminescence with high quantum yields is particularly noteworthy because other presently available methods have failed to provide embodiments of Group IV semiconductor nanoparticles that exhibit photoluminescence that is stable over long periods. As previously mentioned, though photoluminescence is observable for some embodiments of Group IV semiconductor nanoparticles in the size range of about 1.0 nm to about 4.0 nm, what is disclosed herein is applicable to the production of stable Group IV semiconductor nanoparticles across a range of sizes, including nanoparticles greater than about 4.0 nm, which do not display photoluminescence in the visible range of the electromagnetic spectrum.

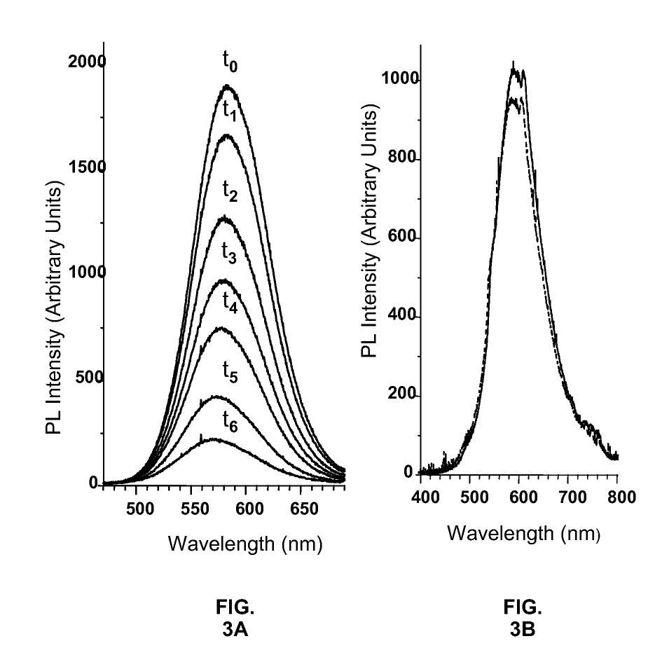

An example of the stability of embodiments of the disclosed Group IV semiconductor nanoparticles as monitored by the photoluminsecent stability of Group IV semiconductor nanoparticles in the size range of between about 1.0 nm to about 4.0 nm is shown in FIGS. 3A and 3B, which are photoluminescence spectra of silicon nanoparticles of about 2.0 nm in diameter taken under 365 nm UV excitation. The particles were prepared using a laser pyrolysis method, followed by an etching process previously described herein. In FIG. 3A, the instability of the silicon nanoparticles in ambient conditions is clearly shown. At t₀ the photoluminescent intensity (PLI) is at a maximum. At times t₁-t₄, representing 3 minutes, 7 minutes, 17 minutes, and 46 minutes, respectively, it is clear that the PLI is rapidly dropping, so that within 46 minutes is only about 25% of the original intensity. Finally for t₅ and t₆, representing 3 hours and 6 hours, the PLI continues to drop, so that within 6 hours of exposure in ambient conditions, the silicon nanoparticles have only about 12% of the original intensity.

For FIG. 3B the PLI response is shown for an embodiment of disclosed Group IV stably passivated nanoparticles, using of the 2.0 nm nanoparticles formed as the nanoparticles used in FIG. 3A, then passivated in inert, substantially oxygen-free conditions using hydrosilylation to produce a stable octadecyl organic passivation layer. Here, the initial PLI response is shown for the photoluminescence spectrum in solid line versus a response of the same material taken almost 4 days later, indicated by the hatched spectrum. Given the inherent variability of the analytical technique, there is no significant difference between the two responses. In some exemplary embodiments, the present methods have provided Group IV semiconductor nanoparticles that have been monitored for photoluminescent with a high photoluminescence intensity that has been stable for two years without signs of appreciable degradation. For the purposes of this disclosure, photoluminescence intensity is stable if it changes by no more than about 10% over a designated period of time

In some exemplary embodiments, the present methods provide Group IV semiconductor nanoparticles that photoluminescence with a photoluminescence quantum yield of at least 10%. This includes embodiments where the photoluminescence quantum yield has been demonstrated to be at least 40%, as well as embodiments where the quantum yield has been demonstrated to be at least 50% and further includes embodiments where the photoluminescence quantum yield has been demonstrated to be at least 60%.

Additionally, it should be noted that embodiments of the disclosed Group IV semiconductor nanoparticles are also different with respect to indications by FTIR that the materials produced using inert, substantially oxygen-free conditions have no detectable or substantially low quantities of silicon oxide at the surface.

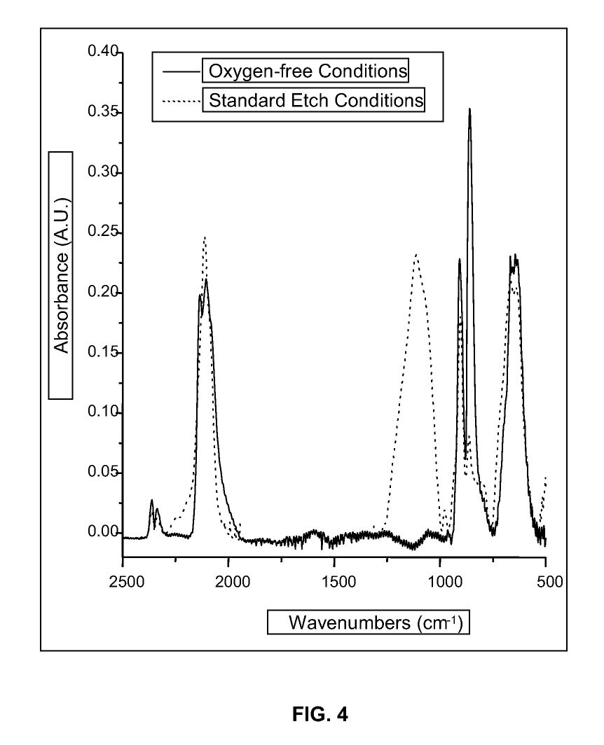

In FIG. 4, FTIR data are presented in which the spectra of etched particles prepared as disclosed herein (solid line) versus standard etch conditions as described in previously discussed article by Swihart, et al. The strong peak at 2100 cm⁻¹ is attributed to Si—H stretching modes, while peaks in the 500 to 910 cm⁻¹ range are attributed to Si—H wagging modes and Si—Si stretching modes. Attention is particularly drawn to the peaks in the 1070 to 1100 cm⁻¹ range, which are attributed to Si—O stretching modes. As it clearly evident from FIG. 4, Group IV silicon nanoparticles prepared as disclosed herein are substantially, if not entirely, free of oxidation.

Dispersions of embodiments of the stably passivated Group IV nanoparticles can be used in compositions to produce inks. For example, if the stable organic passivation layer is hydrophobic, a dispersion of the stably passivated Group IV nanoparticles can be made from the nanoparticles taken up in a hydrophobic solvent, such as, but not limited by low molecular weight hydrocarbon solvents, Alternatively, if the organic passivation layer has a more hydrophilic nature, such as containing heteroatoms, or amine of hydroxyl groups, a dispersion of the stably passivated Group IV nanoparticles can be made from the nanoparticles taken up in hydrophilic solvents, such as, but not limited by alcohols. These examples are illustrative of the range of chemistries that can be used to formulate inks that may be formed from embodiments of the disclosed stably passivated Group IV nanoparticles. As one of ordinary skill in the art is aware, ink dispersions may contain a number of additives, such as stabilizers, agents for adjusting solution viscosity, and antifoaming agents. As such, ink compositions would be optimized for a specific use. Examples of the uses of ink compositions formed from embodiments of the disclosed stably passivated Group IV nanoparticles include, but are not limited by, anticounterfeitting and authentication, labeling, and for use in printed optoelectronic devices such as LEDs, photodiodes, photovoltaic and sensor devices

Images were taken after printing an ink formulation containing the silicon nanocrystals onto a paper substrate. A line was drawn on the paper substrate with a standard ballpoint pen to act as a registration mark. Both photos were taken without moving the camera between images, only a UV lamp (365 nm) and room lights were manipulated to create the composite figure. To print the thin film, the stably passivated silicon nanocrystals were dispersed in toluene. A small volume of PVB, (polyvinyl butyrai)-co-(vihyl alcohol)-co-(vinyl acetate)) in a chloroform/toluene solvent mixture was added to adjust the viscosity of the ink composition. The printed stably passivated silicon nanocrystals could not be seen on the paper under ordinary conditions, while the word “authentic” was visible as the UV light produces luminescence of the printed stably passivated nanocrystals.

Though paper was used as the substrate, a wide variety of substrates are possible. For example, ceramics, glasses, metals, natural polymers, such as cellulose-based materials (e.g. wood, paper, and cardboard), or cotton, as well as synthetic polymers, such as, polyethylene terephthalates (PETs), polyamides, polyimides, polycarbonates, and polypropylenes are contemplated for use, as well as composites and compositions thereof. As will be understood by one of ordinary skill in the art, ink compositions can be optimized for printing on any substrate surface.

The present methods are further illustrated by the following non-limiting example.

### EXAMPLE

### Production of Photoluminescent Group IV Semiconductor Nanocrystals

The example given below is a non-limiting example of a method that may be used to produce stably passivated Group IV semiconductor nanoparticles. In this example, the Group IV semiconductor nanoparticles were silicon nanocrystals of about 2.0 nm in diameter. Stably passivated silicon nanoparticles so produced have high photoluminescence intensity and high photoluminescence quantum yield.

Silicon nanocrystals of about 2.0 nm in diameter were produced using, a radio frequency plasma method and apparatus substantially as described in U.S. patent application Ser. No. 11/155,340. In this method the silicon nanocrystals were produced in a plasma environment, collected on a mesh screen and held under an inert gas atmosphere that was substantially oxygen-free. Without exposing the silicon nanocrystals to air, the screen and the nanocrystals were isolated in a container between two ball valves and transferred under a substantially oxygen-free atmosphere into a nitrogen glove box. In the glove box, the screen was removed from the container and the silicon nanocrystals were washed from the screen using degassed mesitylene solvent. The resulting slurry of nanocrystals was transferred into a glass flask, still in the glove box, and approximately 2 milliliters (mL) of anhydrous octadecene was added to the flask. The slurry was heated to the boiling point of mesitylene until the mixture turned clear (about 1 hour). At this point, the silicon nanocrystals had been hydrosilylated, forming stably passivated silicon nanoparticles thereby. In referring to step 4, of FIG. 2, the stably passivated silicon nanoparticles were removed from inert conditions, and could be purified using typical laboratory procedures.

The above protocol is useful for producing stably passivated Group IV semiconductor nanoparticles between about 1.0 nm to about 100.0 nm in diameter.

For the purposes of this disclosure and unless otherwise specified, “a” or “an” means “one or more”. All patents, applications, references and publications cited herein are incorporated by reference in their entirety to the same extent as if they were individually incorporated by reference.

While the principles of this invention have been described in connection with specific embodiments, it should be understood dearly that these descriptions are made only by way of example and are not intended to limit the scope of the invention. What has been disclosed herein has been provided for the purposes of illustration arid description. It is not intended to be exhaustive or to limit what is disclosed to the precise forms described. Many modifications and variations will be apparent to the practitioner skilled in the art. What is disclosed was chosen and described in order to best explain the principles and practical application of the disclosed embodiments of the art described, thereby enabling others skilled in the art to understand the various embodiments and various modifications that are suited to the particular use contemplated. It is intended that the scope of what is disclosed be defined by the following claims and their equivalence.

What is claimed is:

1. A method for producing Group IV semiconductor nanoparticles, the method comprising:
(a) producing semiconductor nanoparticles in an inert environment; wherein the semiconductor nanoparticles are formed from at least one Group IV semiconductor element;
(b) transferring the semiconductor nanoparticles to an inert reaction solution in an inert environment; and
(c) reacting the surfaces of the semiconductor nanoparticles in the inert reaction solution to form an organic passivation layer covalently bonded to the semiconductor nanoparticles.

2. The method of claim 1, wherein the inert environment substantially oxygen free.

3. The method of claim 2, wherein the inert, substantially oxygen-free environment is up to about 100 ppb oxygen.

4. The method of claim 2, wherein the inert, substantially oxygen-free environment is up to about 100 ppm oxygen.

5. The method of claim 1 wherein the inert reaction solution is substantially oxygen-free.

6. The method of claim 5, wherein the inert, substantially oxygen-free solution up to about 100 ppb oxygen.

7. The method of claim 5, wherein the inert, substantially oxygen-free solution up to about 100 ppm oxygen.

8. The method of claim 1, wherein the step of producing semiconductor nanoparticles in a substantially inert environment comprises etching the nanoparticles to provide nanoparticles having a desired size and further processing the nanoparticles under an inert atmosphere.

9. The method of claim 1, wherein the step of producing semiconductor nanoparticles in an inert environment comprises etching the nanoparticles to provide nanoparticles having a desired size and transferring the nanoparticles in an inert liquid.

10. The method of claim 1, wherein the step of producing semiconductor nanoparticles in an inert environment comprises forming the nanoparticles in a gas or plasma phase in an inert gas atmosphere.

11. The method of claim 1, wherein the step of transferring the semiconductor nanoparticles in an inert environment comprises transferring the nanoparticles under vacuum or an inert gas environment.

12. The method of claim 1, wherein the step of reacting the surfaces of the semiconductor nanoparticles in the inert reaction solvent comprises reacting the semiconductor nanoparticles with an anhydrous reaction solvent under an inert gas atmosphere.

13. The method of claim 1, wherein the step of reacting the surfaces of the semiconductor nanoparticles in the inert reaction solvent comprises an insertion reaction.

14. The method of claim 13, wherein insertion comprises the reaction between a surface Group IV semiconductor hydrogen-bonded moiety and an unsaturated carbon moiety.

15. The method of claim 1, wherein the Group IV semiconductor nanoparticles produce luminescence.

16. Group IV semiconductor nanoparticles made according to the method of claim 1.

17. Semiconductor nanoparticles comprising, Group IV semiconductor nanoparticles having an organic passivation layer, wherein the nanoparticles are substantially oxide free.

18. The Group IV semiconductor nanoparticles of claim 17, wherein the semiconductor nanoparticles are colloidal nanoparticles.

19. The Group IV semiconductor nanoparticles of claim 18, wherein the colloidal semiconductor nanoparticles are silicon nanocrystals.

20. The Group IV semiconductor nanoparticles of claim 18, wherein the colloidal semiconductor nanoparticles are germanium nanocrystals.

21. The Group IV semiconductor nanoparticles of claim 18, wherein the colloidal semiconductor nanoparticles are alloys of at least two Group IV semiconductor elements.

22. The Group IV semiconductor nanoparticles of claim 18, wherein the colloidal semiconductor nanoparticles are core/shell nanocrystals of Group IV semiconductor elements.

23. The Group IV semiconductor nanoparticles of claim 17, wherein the semiconductor nanoparticles are between about 1.0 nm to about 100.0 nm in diameter.

24. A composition of Group IV semiconductor nanoparticles comprising passivated Group IV nanoparticles, which nanoparticles are substantially oxide free, wherein the nanoparticles are dispersed in a solution.

25. The composition of claim 24, wherein the solution of nanoparticles is used for printing on a substrate.

26. A composition of Group IV semiconductor nanoparticles comprising passivated Group IV semiconductor nanoparticles made according to the method of claim 1, wherein the nanoparticles are dispersed in a solution.

27. The composition of claim 26, wherein the solution of nanoparticles is used for printing on a substrate.
